(19) United States
(12) Patent Application Publication
(10) Pub. No.: US 2026/0316013 A1
(43) Pub. Date: Oct. 15, 2026

(54) VEGETABLE OIL PRODUCTION DEVICE AND VEGETABLE OIL PRODUCTION METHOD

(71) Applicant: GUANGXI UNIVERSITY, Guangxi (CN)

(72) Inventors: Debao NIU, Guangxi (CN); Lili GAI, Guangxi (CN); Kai LI, Guangxi (CN); Yuyang HE, Guangxi (CN); Fangxue HANG, Guangxi (CN)

(21) Appl. No.: 18/855,703

(22) PCT Filed: Jul. 9, 2024
(86) PCT No.: PCT/CN2024/104408

§ 371 Date: Oct. 10, 2024

(30) Foreign Application Priority Data
Dec. 28, 2023 (CN) 202311844950.8

(51) Int. Cl. B01D 69/04; B01D 65/02; B01D 71/02; C11B 3/00

(52) U.S. Cl. CPC B01D 69/04; B01D 65/02; B01D 71/02; C11B 3/008; B01D 2313/10; B01D 2313/12; B01D 2313/18; B01D 2313/243; B01D 2317/04; B01D 2321/02

(57) ABSTRACT

Provided are a vegetable oil production device and a vegetable oil production method. The device includes a raw material tank, a heat exchanger and a membrane structure. The membrane structure includes multiple membrane assemblies which are in communication in sequence, and each membrane assembly includes multiple membrane tubes which are arranged in parallel. The raw material tank is provided with a feed port, a discharge port of the raw material tank communicates with a feed port of the membrane structure and a sewage pipe, a clear liquid outlet of the membrane structure communicates with a collection structure, a feed port of the heat exchanger communicates with a discharge port of the membrane structure, a discharge port of the membrane structure further communicates with the sewage pipe, and a discharge port of the heat exchanger communicates with a return port of the raw material tank.

### CROSS REFERENCE TO RELATED APPLICATION

This application is a national stage application of International Patent Application No. PCT/CN2024/104408, filed on Jul. 9, 2024, which claims the priority of Chinese Patent Application No. 2023118449508 entitled “VEGETABLE OIL PRODUCTION DEVICE AND VEGETABLE OIL PRODUCTION METHOD” filed with the Chinese Patent Office on Dec. 28, 2023, which is incorporated herein by reference in its entirety.

### TECHNICAL FIELD

The present disclosure relates to the technical field of vegetable oil production, and in particular to a vegetable oil production device with multiple groups of tubular ceramic membranes in parallel, and a vegetable oil production method.

### BACKGROUND

The traditional vegetable oil production method usually refers to refining crude oil. The existence of impurities in the crude oil not only affects the edible value and storage safety of oil, but also brings difficulties to the deep processing of oil. During refining, impurities that have adverse effects on eating, storage and industrial production, such as mucus, metals, phospholipids, free fatty acids and pigments need to be removed as much as possible. Meanwhile, the original nutritional active substances, such as squalene, phytosterol and vitamins, should be preserved as much as possible. However, the traditional refining methods for the vegetable oil, including soybean oil, peanut oil and cottonseed oil, all subject to chemical refining processes such as degumming, desolventizing, deacidification, decoloration and deodorization, and there are some problems such as complicated procedures and excessive processing (e.g., the usage of a lot of chemicals and undergoing high temperature treatment), leading to serious loss of nutritional active substances in the vegetable oil products after chemical refining, which may generate harmful substances such as chemical residues, trans fatty acids and chloropropanol. For example, the refining methods for camellia oil include degumming, deacidification, decoloration, deodorization and dewaxing processes, although the refining method for the camellia oil can remove non-triglyceride impurities from the crude oil, the quality of the camellia oil will be affected by the addition of chemical reagents and the process of high temperature treatment, and some substances beneficial to human body will be destroyed, for example, squalene, phytosterol and vitamin E basically disappear. Therefore, there is an urgent need to find a green physical process capable of retaining nutrients to the greatest extent while achieving low energy consumption and high efficiency.

At present, under the requirements of comprehensive health and nutrition standards, the purpose of oil processing is to remove unnecessary and harmful impurities from the oil according to different requirements and uses, so when the vegetable refined oil reaches the Chinese national standards, the processing efficiency is improved, and the original active nutrients are reserved to the greatest extent.

### SUMMARY

An objective of the present disclosure is to provide a vegetable oil production device and a vegetable oil production method. The problems of chemical reagent addition caused by over-processing in the traditional vegetable oil refining process and loss of active substances and heat-sensitive substances in the vegetable oil caused by high-temperature refining are solved.

To achieve the objective above, the present disclosure employs the following technical solutions.

A vegetable oil production device includes a raw material tank, a heat exchanger and a membrane structure, where the membrane structure includes multiple membrane assemblies which are in communication in sequence, and each of the multiple membrane assemblies includes multiple membrane tubes which are arranged in parallel; the raw material tank is provided with a feed port, a discharge port of the raw material tank communicates with a feed port of the membrane structure and a sewage pipe, a clear liquid outlet of the membrane structure communicates with a collection structure, a feed port of the heat exchanger communicates with a discharge port of the membrane structure, the discharge port of the membrane structure also communicates with the sewage pipe, and a discharge port of the heat exchanger communicates with a return port of the raw material tank.

Preferably, a filter assembly is arranged between the discharge port of the raw material tank and the feed port of the membrane structure, the filter assembly communicates with the sewage pipe, and includes at least two filters arranged in parallel; and each filter communicates with the discharge port of the raw material tank and the feed port of the membrane structure.

Preferably, a feeding pump is arranged between the discharge port of the raw material tank and the feed port of the membrane structure, the feeding pump communicates with the sewage pipe; and a pipeline between the feeding pump and the filter assembly communicates with the sewage pipe.

Preferably, a liquid level gauge and a temperature sensor are arranged in the raw material tank.

Preferably, a circulating pump is arranged in the membrane structure, the circulating pump is arranged on a pipeline between the membrane assemblies, and communicates with the sewage pipe.

Preferably, the vegetable oil production device further includes a pickling batching tank and an alkaline washing batching tank, where the pickling batching tank and the alkaline washing batching tank both communicate with the raw material tank; and the raw material tank is further provided with a water inlet, and the water inlet is configured to communicate with an external water source.

Preferably, each of a pipeline communicating between the pickling batching tank and the raw material tank and a pipeline communicating between the alkaline washing batching tank and the raw material tank is provided with a metering pump.

The vegetable oil production device further includes a hot air blower. An air outlet of the hot air blower communicates with the raw material tank.

A vegetable oil production method using the vegetable oil production device is further provided by the present disclosure. A filtering process includes the following steps.

Step one: pouring materials into a raw material tank, opening a second valve at a discharge port of the raw material tank, a third valve of a filter assembly, and a return valve at a discharge port of a heat exchanger;

Step two: turning on a feeding pump, conveying the materials in the raw material tank to a membrane structure, filling a membrane structure and each pipeline with the materials, and exhausting air in the membrane structure and each pipeline;

Step three: opening a first valve at a clear liquid outlet of the membrane structure, turning on a circulating pump to make the materials circulate in each membrane assembly of the membrane structure;

Step four: regulating a degree of opening of the first valve so as to keep a pressure gauge at the clear liquid outlet of the membrane structure within a range of a working pressure, and enabling clear liquid of the materials in the multiple membrane assemblies to permeate a side wall of each membrane tube in the multiple membrane assemblies under an action of a transmembrane pressure difference between the circulating pump and the multiple membrane assemblies; and

Step five: collecting the clear liquid flowing out from the clear liquid outlet of the membrane structure, returning concentrated liquid remaining in the membrane structure after filtering to the raw material tank for second filtering after heat exchange by the heat exchanger, and stopping the circulating pump and the feeding pump in turn after the second filtering is completed.

A cleaning process includes the following steps:

Step one: opening a first emptying valve at the discharge port of the raw material tank to empty the raw material tank, opening a second emptying valve between the filter assembly and a sewage pipe to empty the filter assembly, opening a third emptying valve between the feeding pump and the sewage pipe to empty the feeding pump, opening a fourth emptying valve between a discharge port of the membrane structure and the sewage pipe to empty the membrane structure, and opening a fifth emptying valve between the circulating pump and the sewage pipe to empty the circulating pump;

Step two: introducing water into the raw material tank through a water inlet, introducing pickling liquid from a pickling batching tank and alkaline washing liquid from an alkaline washing batching tank into the raw material tank, opening the third valve of the filter assembly and the return valve at the discharge port of the heat exchanger, and turning on the feeding pump and the circulating pump for cleaning;

Step three: stopping the circulating pump and the feeding pump in turn after the cleaning is completed; and

Step four: turning on a hot air blower to evaporate moisture in the device and a pipeline.

Compared with the prior art, the present disclosure has the following technical effects:

Compared with the prior art, some embodiments have the following advantages of high efficiency and stability, low-temperature filtering, and convenient cleaning. The high efficiency and stability are achieved as follows: multiple membrane tubes are respectively arranged in multiple membrane assemblies to increase membrane area and improve filtering efficiency, making the continuous and stable filtering time long. Low-temperature filtering is achieved as follows: a heat exchanger is provided, an ethanol medium can be introduced by an external circulating refrigerator, thus achieving low-temperature filtering and reserving active substances and heat-sensitive substances in the vegetable oil to the greatest extent. Convenient cleaning is achieved as follows: a hot air blower is provided, after device is cleaned by pickling liquid and alkaline washing liquid, the device and pipeline can be rapidly dried to evaporate internal moisture, thus facilitating the production of the next batch and saving time.

### BRIEF DESCRIPTION OF THE DRAWINGS

In order to illustrate the embodiments of the present disclosure or the technical solutions in the prior art more clearly, the drawings needed in the embodiments will be briefly introduced hereinafter. Apparently, the drawings in the following description are only some embodiments of the present disclosure. For those skilled in the art, other drawings can be obtained according to these drawings without paying creative labor.

FIG. 1 is a schematic diagram of a vegetable oil production device according to the present disclosure;

FIG. 2 is a sketch of a vegetable oil production device according to the present disclosure.

In the drawings: 1 membrane assembly; 2 electric control cabinet; 3 feeding pump; 4 circulating pump; 5 raw material tank; 6 pickling batching tank; 7 alkaline washing batching tank; 8 heat exchanger; 9 filter; 10 metering pump; 11 sewage pipe; 12 first valve; 13 second valve; 14 third valve; 15 fourth valve; 16 first emptying valve; 17 second emptying valve; 18 third emptying valve; 19 fourth emptying valve; 20 fifth emptying valve; 21 pressure gauge; 22 hot air blower; and 23 return valve.

### DETAILED DESCRIPTION OF THE EMBODIMENTS

The technical solutions in the embodiments of the present disclosure will be described clearly and completely hereinafter with reference to the drawings of the embodiments of the present disclosure. Apparently, the described embodiments are some embodiments of the present disclosure, rather than all of the embodiments. Based on the embodiments of the present disclosure, all other embodiments obtained by those skilled in the art without paying creative labor fall in the scope of protection of the present disclosure.

An objective of the present disclosure is to provide a vegetable oil production device and a vegetable oil production method. The problems of chemical reagent addition caused by over-processing in the traditional vegetable oil refining process and loss of active substances and heat-sensitive substances in the vegetable oil caused by high-temperature refining are solved.

In order to make the above objects, features and advantages of the present disclosure more obvious and understandable, the present disclosure will be further explained in detail hereinafter with reference to the drawings and specific embodiments.

### Embodiment 1

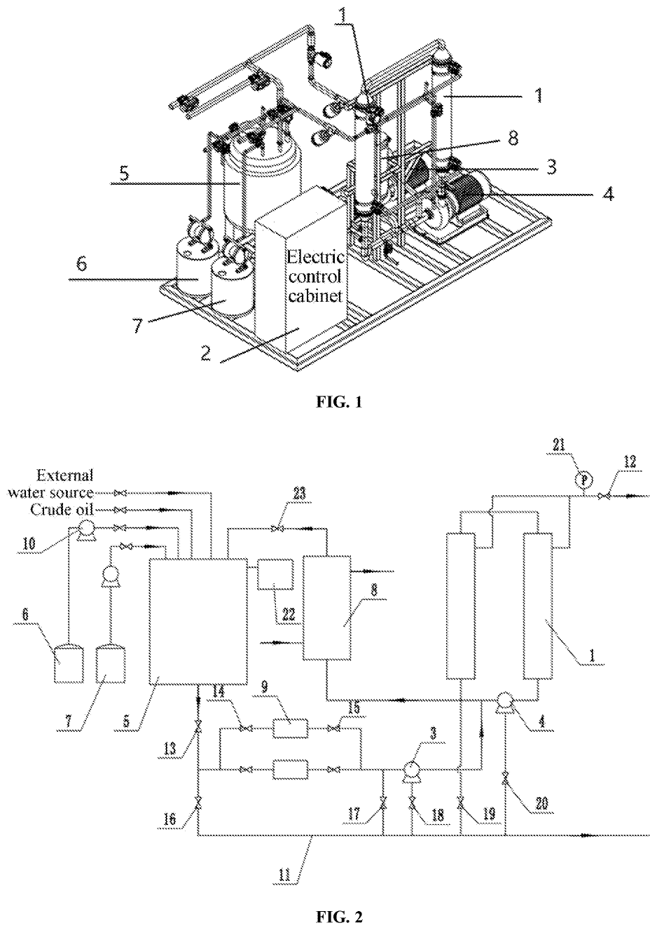

As shown in FIG. 1 and FIG. 2, a vegetable oil production device is provided by this embodiment, including a raw material tank 5, a heat exchanger 8 and a membrane structure. The membrane structure includes two to five membrane assemblies 1 which are in communication in sequence, and each membrane assembly 1 includes ten to twenty ceramic membrane tubes arranged in parallel, each ceramic membrane tube having an aperture from 0.01 μm to 2 μm. The raw material tank 5 is provided with a feed port, and a discharge port of the raw material tank 5 communicates with a feed port of the membrane structure and a sewage pipe 11, respectively. A clear liquid outlet of the membrane structure communicates with a collection structure. The clear liquid outlet of the membrane structure is provided with a first valve 12 and a pressure gauge 21, the working range of the pressure gauge 21 is from 0.01 mpa to 0.9 mpa, a flow rate of clear liquid at the clear liquid outlet is from 0.6 L/min-6.5 L/min. A feed port of the heat exchanger 8 communicates with a discharge port of the membrane structure, and the discharge port of the membrane structure further communicates with the sewage pipe 11. A discharge port of the heat exchanger 8 communicates with a return port of the raw material tank 5. A return valve 23 is arranged between the discharge port of the heat exchanger 8 and the return port of the raw material tank 5, and the heat exchanger 8 is further provided with a medium inlet, and a medium outlet. The membrane tube in this embodiment employs a physical separation technology, and has the advantages of simple operation, high separation efficiency, and accurate and energy conservation. The ceramic membrane has the advantages of resistance to swelling of organic solvents, resistance to acid and alkali, pollution resistance, and easy cleaning. In this embodiment, the vegetable oil is physically purified by the ceramic membrane separation technology to replace the traditional chemical refining process, thus achieving the green and efficient production of high-quality vegetable oil superior to the Chinese national standard.

Specifically, in this embodiment, a liquid level gauge and a temperature sensor are arranged in the raw material tank 5, and the liquid level gauge and the temperature sensor communicate with an electric control cabinet 2, respectively. A second valve 13 is arranged at the discharge port of the raw material tank 5, a pipeline between the second valve 13 and the filter assembly communicates with the sewage pipe 11 by a first connecting pipe, and a first emptying valve 16 is arranged on the first connecting pipe.

In this embodiment, a filter assembly is arranged between the discharge port of the raw material tank 5 and the feed port of the membrane structure, the filter assembly is configured to filter large particles and debris in materials. The filter assembly further communicates with the sewage pipe 11, and includes at least two filters 9 arranged in parallel. Each filter 9 communicates with the discharge port of the raw material tank 5 and the feed port of the membrane structure, respectively, a third valve 14 is arranged between the discharge port of the raw material tank 5 and the filter 9, and a feeding pump 3 is arranged between the filter 9 and the feed port of the membrane structure, making the materials in the raw material tank 5 pumped into the membrane structure. A fourth valve 15 is arranged between the filter 9 and the feeding pump 3, a pipeline between the fourth valve 15 and the feeding pump 3 communicates with the sewage pipe 11 by a second connecting pipe, and a second emptying valve 17 is arranged on the second connecting pipe. The feeding pump 3 communicates with the sewage pipe 11, and a third emptying valve 18 is arranged between the feeding pump 3 and the sewage pipe 11.

In this embodiment, a fourth emptying valve 19 is arranged between the discharge port of the membrane structure and the sewage pipe 11. A circulating pump 4 is arranged in the membrane structure, and the circulating pump 4 is arranged on the pipeline between any two membrane assemblies 1, making the materials achieve cross-flow circulation in the membrane structure. The circulating pump 4 communicates with the sewage pipe 11 by a third connecting pipe, and a fifth emptying valve 20 is arranged on the third connecting pipe.

In this embodiment, the device further includes a cleaning in place (CIP) system which is configured for circular cleaning of pipelines and production equipment. The CIP cleaning system includes a pickling batching tank 6 and an alkaline washing batching tank 7. The pickling batching tank 6 and the alkaline washing batching tank 7 both communicate with the raw material tank 5, each of a pipeline communicating between the pickling batching tank 6 and the raw material tank 5 and a pipeline communicating between the alkaline washing batching tank 7 and the raw material tank 5 is provided with a metering pump 10. The metering pumps 10 are configured to meter the dosage of pickling liquid and alkaline washing liquid. The raw material tank 5 is further provided with a water inlet, and the water inlet is configured for communicating with an external water source.

In this embodiment, the heat exchanger 8 can be additionally provided with a refrigerator and heating equipment to achieve the cooling of the materials and the heating of the cleaning liquid during cleaning.

In this embodiment, the vegetable oil production device further includes a hot air blower 22. An air outlet of the hot air blower 22 communicates with the raw material tank 5.

Through the device of this embodiment, the production of high-quality vegetable oil can be directly completed by one-step method, and the cost is saved. Moreover, the production process belongs to non-thermal physical processing, which is green and environment-friendly, and can reserve the beneficial components in the vegetable oil to the greatest extent while ensuring that the vegetable oil meets the requirements of Chinese national standards.

In this embodiment, the open/close of each valve and on/off of each pump can be controlled by the electric control cabinet 2 to achieve automatic production. Several membrane tubes can produce in parallel to improve the production efficiency. Meanwhile, the heat exchanger 8 is provided, which can achieve low-temperature filtering and ensure the retention of nutrients in the vegetable oil. In addition, in this embodiment, a hot air blower 22 is further provided. After cleaning the device, the device and pipeline can be quickly dried to evaporate the internal moisture, which is beneficial to the production of the next batch and can save time.

In this embodiment, the electric control cabinet 2 is provided with an automatic control system which belongs to a programmable logic controller (PLC), and the control process is the prior art.

### Embodiment 2

This embodiment provides a vegetable oil production method implemented by the vegetable oil production device of Embodiment 1. A filtering process includes the following steps.

Step one: pouring materials into a raw material tank 5, opening a second valve 13 at a discharge port of the raw material tank 5, a third valve 14 of a filter assembly, and a return valve 23 at a discharge port of a heat exchanger 8;

Step two: turning on a feeding pump 3, conveying the materials in the raw material tank 5 to a membrane structure, filling a membrane structure and each pipeline with the materials, and exhausting air to reduce the damage to the membrane tube;

Step three: opening a first valve 12 at a clear liquid outlet of the membrane structure, turning on a circulating pump 4 to make the materials circulate in each membrane assembly 1 of the membrane structure;

Step four: regulating the degree of opening of a first valve 12, so as to keep a pressure gauge 21 at the clear liquid outlet of the membrane structure within the range of a working pressure, and enabling clear liquid of the materials in the membrane assembly 1 to permeate a side wall of each membrane tube in the membrane assembly 1 under the action of a transmembrane pressure difference between the circulating pump 4 and the membrane assembly 1; and

Step five: collecting the clear liquid flowing out from the clear liquid outlet of the membrane structure, returning concentrated liquid remaining in the membrane structure after filtering to the raw material tank 5 for second filtering after heat exchange by the heat exchanger 8, and stopping the circulating pump 4 and a feeding pump in turn after the second filtering is completed.

A cleaning process includes the following steps.

Step one: opening a first emptying valve 16 at the discharge port of the raw material tank 5 to empty the raw material tank 5, opening a second emptying valve 17 between the filter assembly and a sewage pipe 11 to empty the filter assembly, opening a third emptying valve 18 between the feeding pump 3 and the sewage pipe 11 to empty the feeding pump 3, opening a fourth emptying valve 19 between a discharge port of the membrane structure and the sewage pipe 11 to empty the membrane structure, and opening a fifth emptying valve 20 between the circulating pump 4 and the sewage pipe 11 to empty the circulating pump 4;

Step two: introducing water into the raw material tank 5 through a water inlet, introducing pickling liquid from a pickling batching tank 6 and alkaline washing liquid from an alkaline washing batching tank 7 into the raw material tank 5, opening a third valve 14 of the filter assembly and a return valve 23 at a discharge port of the heat exchanger 8, and turning on the feeding pump 3 and the circulating pump 4 for cleaning;

Step three: stopping the circulating pump 4 and the feeding pump in turn after the cleaning is completed; and

Step four: turning on a hot air blower 22 to evaporate moisture in the device and a pipeline.

### Application Example 1

Crude camellia oil is introduced into the raw material tank 5, the raw material tank 5 is started to run under the control of a control system. The crude camellia oil is pumped to the membrane structure by the feeding pump 3 for filtering production, and the filtered camellia oil flows out the first valve 12 from the clear liquid outlet of the membrane structure, and permeated liquid obtained by the vegetable oil production device is clear liquid of the camellia oil. After the filtering procedure is finished, the device is cleaned. Under the control of the control system, the CIP cleaning procedure is started through the pickling batching tank 6 and the alkaline washing batching tank 7 to perform pickling and alkaline washing on the device and pipeline. The hot air blower 22 is configured to quickly evaporate the moisture in the device and pipeline.

Filtering operation parameters of the membrane structure are as follows: there are two membrane assemblies 1, each membrane assembly 1 is composed of fifteen ceramic membrane tubes, an aperture of the membrane is 0.3 μm, the reading of the pressure gauge 21 is 0.2 Mpa, and the flow rate is 1.5 L/min.

### Application Example 2

The filtering process and cleaning process of this application example are consistent with those of Application example 1, except that

the filtering operation parameters of the membrane structure are as follows: there are two membrane assemblies 1, each membrane assembly 1 is composed of fifteen ceramic membrane tubes, an aperture of the membrane is 0.25 μm, the reading of the pressure gauge 21 is 0.3 Mpa, and the flow rate is 2.5 L/min.

### Application Example 3

The filtering process and cleaning process of this application example are consistent with those of Application example 1, except that

the filtering operation parameters of the membrane structure are as follows: there are two membrane assemblies 1, each membrane assembly 1 is composed of fifteen ceramic membrane tubes, an aperture of the membrane is 0.2 μm, the reading of the pressure gauge 21 is 0.4 Mpa, and the flow rate is 3.5 L/min.

### Application Example 4

The filtering process and cleaning process of this application example are consistent with those of Application example 1, except that

the filtering operation parameters of the membrane structure are as follows: there are two membrane assemblies 1, each membrane assembly 1 is composed of fifteen ceramic membrane tubes, an aperture of the membrane is 0.15 μm, the reading of the pressure gauge 21 is 0.5 Mpa, and the flow rate is 4.5 L/min.

The quality of the camellia oil produced according to Application examples 1 to 4 of the vegetable oil production device and the vegetable oil production method provided by the present disclosure is determined. An acid value is determined according to determination requirements of acid value in foods of Chinese National Standard GB 5009.229-2016, a peroxide value is determined according to determination requirements of peroxide value in foods of Chinese National Standard GB 5009.227-2023, the moisture and volatile matters are determined according to determination requirements of moisture and volatile matter in animal and vegetable fats and oils of Chinese National Standard GB 5009.236-2016, and the insoluble impurities are determined according to the determination requirements of insoluble impurities in animal and vegetable fats and oils of Chinese National Standard GB/T 15688-2008. Squalene is determined according to determination requirements of squalene content in oilseeds of Agricultural standard NY/T 3673-2020, vitamin E (tocopherol) is determined according to determination requirements of vitamins A, D and E in foods of Chinese National Standard GB 5009.82-2016, and phytosterol is determined according to determination requirements of gas chromatographic method for determining individual and total sterols contents in animal and vegetable fats and oils of Chinese National Standard GB/T 25223-2010.

TABLE 1
Quality detection result of camellia oil produced by vegetable oil production
device and vegetable oil production method provided by the present disclosure

| | Acid value | | Moisture and | | | | |
|---|---|---|---|---|---|---|---|
| | (Counted | Peroxide | volatile | Insoluble | | | α-vitamin |
| Serial | by KOH) | value | matter | impurity | Phytosterol | Squalene | E |
| number | (mg/g) | (g/100 g) | content (%) | content (%) | (mg/100 g) | (mg/kg) | (mg/100 g) |
| Application | 0.85 | 0.24 | 0.08 | 0.05 | 346.27 | 30.14 | 37.53 |
| example 1 | | | | | | | |
| Application | 0.79 | 0.21 | 0.06 | 0.04 | 356.96 | 32.28 | 40.36 |
| example 2 | | | | | | | |
| Application | 0.72 | 0.18 | 0.07 | 0.02 | 376.28 | 36.82 | 43.56 |
| example 3 | | | | | | | |
| Application | 0.63 | 0.14 | 0.05 | 0.01 | 389.26 | 40.69 | 49.28 |
| example 4 | | | | | | | |

As can be seen from the above table that the acid value, the peroxide value, the moisture and volatile matter content and the insoluble impurity content of the camellia oil produced by the vegetable oil production device and production method according to the present disclosure are significantly lower than the requirements of Chinese National Standard GB/T 11765-2018, and the nutrients, such as phytosterol, squalene and a-vitamin E, of the camellia oil in Application examples 1 to 4 are all reserved, indicating that the camellia oil produced by the vegetable oil production device and the production method according to the present disclosure can retain the nutrients to the greatest extent.

In this specification, specific embodiments aim to illustrate the principle and implementation of the present disclosure. The explanation of the above embodiments is only used to help understand the method and its core idea of the present disclosure. According to the idea of the present disclosure, there will be some changes in the specific implementation and application scope for those skilled in the art. To sum up, the contents of this specification should not be construed as limiting the present disclosure.

1. A vegetable oil production device, comprising a raw material tank, a heat exchanger and a membrane structure, wherein the membrane structure comprises a plurality of membrane assemblies which are in communication in sequence, and each of the plurality of membrane assemblies comprises a plurality of membrane tubes which are arranged in parallel; the raw material tank is provided with a feed port, a discharge port of the raw material tank communicates with a feed port of the membrane structure and a sewage pipe, a clear liquid outlet of the membrane structure communicates with a collection structure, a feed port of the heat exchanger communicates with a discharge port of the membrane structure, the discharge port of the membrane structure also communicates with the sewage pipe, and a discharge port of the heat exchanger communicates with a return port of the raw material tank.

2. The vegetable oil production device according to claim 1, wherein a filter assembly is arranged between the discharge port of the raw material tank and the feed port of the membrane structure, the filter assembly communicates with the sewage pipe, and comprises at least two filters arranged in parallel; and each filter communicates with the discharge port of the raw material tank and the feed port of the membrane structure.

3. The vegetable oil production device according to claim 2, wherein a feeding pump is arranged between the discharge port of the raw material tank and the feed port of the membrane structure, the feeding pump communicates with the sewage pipe; and a pipeline between the feeding pump and the filter assembly communicates with the sewage pipe.

4. The vegetable oil production device according to claim 1, wherein a liquid level gauge and a temperature sensor are arranged in the raw material tank.

5. The vegetable oil production device according to claim 1, wherein a circulating pump is arranged in the membrane structure, the circulating pump is arranged on a pipeline between the membrane assemblies, and communicates with the sewage pipe.

6. The vegetable oil production device according to claim 1, further comprising a pickling batching tank and an alkaline washing batching tank, wherein the pickling batching tank and the alkaline washing batching tank both communicate with the raw material tank; and the raw material tank is further provided with a water inlet, and the water inlet is configured to communicate with an external water source.

7. The vegetable oil production device according to claim 6, wherein each of a pipeline communicating between the pickling batching tank and the raw material tank and a pipeline communicating between the alkaline washing batching tank and the raw material tank is provided with a metering pump.

8. The vegetable oil production device according to claim 1, further comprising a hot air blower, wherein an air outlet of the hot air blower communicates with the raw material tank.

9. A vegetable oil production method implemented by the vegetable oil production device according to claim 1, comprising:
a filtering process comprising following steps:
step one: pouring materials into the raw material tank, opening a second valve at the discharge port of the raw material tank, a third valve of the filter assembly, and a return valve at the discharge port of the heat exchanger;
step two: turning on a feeding pump, conveying the materials in the raw material tank to the membrane structure, filling the membrane structure and each pipeline with the materials, and exhausting air in the membrane structure and each pipeline;
step three: opening a first valve at the clear liquid outlet of the membrane structure, turning on a circulating pump to make the materials circulate in each of the plurality of membrane assemblies of the membrane structure;
step four: regulating a degree of opening of the first valve so as to keep a pressure gauge at the clear liquid outlet of the membrane structure within a range of a working pressure, and enabling clear liquid of the materials in the plurality of membrane assemblies to permeate a side wall of each membrane tube under an action of a transmembrane pressure difference between the circulating pump and the plurality of membrane assemblies; and
step five: collecting the clear liquid flowing out from the clear liquid outlet of the membrane structure, returning concentrated liquid remaining in the membrane structure after filtering to the raw material tank for second filtering after heat exchange by the heat exchanger, and stopping the circulating pump and the feeding pump in turn after the second filtering is completed;
a cleaning process comprising following steps:
step one: opening a first emptying valve at the discharge port of the raw material tank to empty the raw material tank, opening a second emptying valve between the filter assembly and the sewage pipe to empty the filter assembly, opening a third emptying valve between the feeding pump and the sewage pipe to empty the feeding pump, opening a fourth emptying valve between the discharge port of the membrane structure and the sewage pipe to empty the membrane structure, and opening a fifth emptying valve between the circulating pump and the sewage pipe to empty the circulating pump;
step two: introducing water into the raw material tank through a water inlet, introducing pickling liquid from a pickling batching tank and alkaline washing liquid from an alkaline washing batching tank into the raw material tank, opening the third valve of the filter assembly and the return valve at the discharge port of the heat exchanger, and turning on the feeding pump and the circulating pump for cleaning;
step three: stopping the circulating pump and the feeding pump in turn after the cleaning is completed; and
step four: turning on a hot air blower to evaporate moisture in the device and a pipeline.

10. A vegetable oil production method implemented by the vegetable oil production device according to claim 2, comprising:
a filtering process comprising following steps:
step one: pouring materials into the raw material tank, opening a second valve at the discharge port of the raw material tank, a third valve of the filter assembly, and a return valve at the discharge port of the heat exchanger;
step two: turning on the feeding pump, conveying the materials in the raw material tank to the membrane structure, filling the membrane structure and each pipeline with the materials, and exhausting air in the membrane structure and each pipeline;
step three: opening a first valve at the clear liquid outlet of the membrane structure, turning on a circulating pump to make the materials circulate in each of the plurality of membrane assemblies of the membrane structure;
step four: regulating a degree of opening of the first valve so as to keep a pressure gauge at the clear liquid outlet of the membrane structure within a range of a working pressure, and enabling clear liquid of the materials in the plurality of membrane assemblies to permeate a side wall of each membrane tube under an action of a transmembrane pressure difference between the circulating pump and the plurality of membrane assemblies; and
step five: collecting the clear liquid flowing out from the clear liquid outlet of the membrane structure, returning concentrated liquid remaining in the membrane structure after filtering to the raw material tank for second filtering after heat exchange by the heat exchanger, and stopping the circulating pump and the feeding pump in turn after the second filtering is completed;
a cleaning process comprising following steps:
step one: opening a first emptying valve at the discharge port of the raw material tank to empty the raw material tank, opening a second emptying valve between the filter assembly and the sewage pipe to empty the filter assembly, opening a third emptying valve between the feeding pump and the sewage pipe to empty the feeding pump, opening a fourth emptying valve between the discharge port of the membrane structure and the sewage pipe to empty the membrane structure, and opening a fifth emptying valve between the circulating pump and the sewage pipe to empty the circulating pump;
step two: introducing water into the raw material tank through a water inlet, introducing pickling liquid from a pickling batching tank and alkaline washing liquid from an alkaline washing batching tank into the raw material tank, opening the third valve of the filter assembly and the return valve at the discharge port of the heat exchanger, and turning on the feeding pump and the circulating pump for cleaning;
step three: stopping the circulating pump and the feeding pump in turn after the cleaning is completed; and
step four: turning on a hot air blower to evaporate moisture in the device and a pipeline.

11. A vegetable oil production method implemented by the vegetable oil production device according to claim 3, comprising:
a filtering process comprising following steps:
step one: pouring materials into the raw material tank, opening a second valve at the discharge port of the raw material tank, a third valve of the filter assembly, and a return valve at the discharge port of the heat exchanger;
step two: turning on the feeding pump, conveying the materials in the raw material tank to the membrane structure, filling the membrane structure and each pipeline with the materials, and exhausting air in the membrane structure and each pipeline;
step three: opening a first valve at the clear liquid outlet of the membrane structure, turning on a circulating pump to make the materials circulate in each of the plurality of membrane assemblies of the membrane structure;
step four: regulating a degree of opening of the first valve so as to keep a pressure gauge at the clear liquid outlet of the membrane structure within a range of a working pressure, and enabling clear liquid of the materials in the plurality of membrane assemblies to permeate a side wall of each membrane tube under an action of a transmembrane pressure difference between the circulating pump and the plurality of membrane assemblies; and
step five: collecting the clear liquid flowing out from the clear liquid outlet of the membrane structure, returning concentrated liquid remaining in the membrane structure after filtering to the raw material tank for second filtering after heat exchange by the heat exchanger, and stopping the circulating pump and the feeding pump in turn after the second filtering is completed;
a cleaning process comprising following steps:
step one: opening a first emptying valve at the discharge port of the raw material tank to empty the raw material tank, opening a second emptying valve between the filter assembly and the sewage pipe to empty the filter assembly, opening a third emptying valve between the feeding pump and the sewage pipe to empty the feeding pump, opening a fourth emptying valve between the discharge port of the membrane structure and the sewage pipe to empty the membrane structure, and opening a fifth emptying valve between the circulating pump and the sewage pipe to empty the circulating pump;
step two: introducing water into the raw material tank through a water inlet, introducing pickling liquid from a pickling batching tank and alkaline washing liquid from an alkaline washing batching tank into the raw material tank, opening the third valve of the filter assembly and the return valve at the discharge port of the heat exchanger, and turning on the feeding pump and the circulating pump for cleaning;
step three: stopping the circulating pump and the feeding pump in turn after the cleaning is completed; and
step four: turning on a hot air blower to evaporate moisture in the device and a pipeline.

12. A vegetable oil production method implemented by the vegetable oil production device according to claim 4, comprising:
a filtering process comprising following steps:
step one: pouring materials into the raw material tank, opening a second valve at the discharge port of the raw material tank, a third valve of the filter assembly, and a return valve at the discharge port of the heat exchanger;
step two: turning on a feeding pump, conveying the materials in the raw material tank to the membrane structure, filling the membrane structure and each pipeline with the materials, and exhausting air in the membrane structure and each pipeline;
step three: opening a first valve at the clear liquid outlet of the membrane structure, turning on a circulating pump to make the materials circulate in each of the plurality of membrane assemblies of the membrane structure;
step four: regulating a degree of opening of the first valve so as to keep a pressure gauge at the clear liquid outlet of the membrane structure within a range of a working pressure, and enabling clear liquid of the materials in the plurality of membrane assemblies to permeate a side wall of each membrane tube under an action of a transmembrane pressure difference between the circulating pump and the plurality of membrane assemblies; and
step five: collecting the clear liquid flowing out from the clear liquid outlet of the membrane structure, returning concentrated liquid remaining in the membrane structure after filtering to the raw material tank for second filtering after heat exchange by the heat exchanger, and stopping the circulating pump and the feeding pump in turn after the second filtering is completed;
a cleaning process comprising following steps:
step one: opening a first emptying valve at the discharge port of the raw material tank to empty the raw material tank, opening a second emptying valve between the filter assembly and the sewage pipe to empty the filter assembly, opening a third emptying valve between the feeding pump and the sewage pipe to empty the feeding pump, opening a fourth emptying valve between the discharge port of the membrane structure and the sewage pipe to empty the membrane structure, and opening a fifth emptying valve between the circulating pump and the sewage pipe to empty the circulating pump;
step two: introducing water into the raw material tank through a water inlet, introducing pickling liquid from a pickling batching tank and alkaline washing liquid from an alkaline washing batching tank into the raw material tank, opening the third valve of the filter assembly and the return valve at the discharge port of the heat exchanger, and turning on the feeding pump and the circulating pump for cleaning;
step three: stopping the circulating pump and the feeding pump in turn after the cleaning is completed; and
step four: turning on a hot air blower to evaporate moisture in the device and a pipeline.

13. A vegetable oil production method implemented by the vegetable oil production device according to claim 5, comprising:
a filtering process comprising following steps:
step one: pouring materials into the raw material tank, opening a second valve at the discharge port of the raw material tank, a third valve of the filter assembly, and a return valve at the discharge port of the heat exchanger;
step two: turning on a feeding pump, conveying the materials in the raw material tank to the membrane structure, filling the membrane structure and each pipeline with the materials, and exhausting air in the membrane structure and each pipeline;
step three: opening a first valve at the clear liquid outlet of the membrane structure, turning on the circulating pump to make the materials circulate in each of the plurality of membrane assemblies of the membrane structure;
step four: regulating a degree of opening of the first valve so as to keep a pressure gauge at the clear liquid outlet of the membrane structure within a range of a working pressure, and enabling clear liquid of the materials in the plurality of membrane assemblies to permeate a side wall of each membrane tube under an action of a transmembrane pressure difference between the circulating pump and the plurality of membrane assemblies; and
step five: collecting the clear liquid flowing out from the clear liquid outlet of the membrane structure, returning concentrated liquid remaining in the membrane structure after filtering to the raw material tank for second filtering after heat exchange by the heat exchanger, and stopping the circulating pump and the feeding pump in turn after the second filtering is completed;
a cleaning process comprising following steps:
step one: opening a first emptying valve at the discharge port of the raw material tank to empty the raw material tank, opening a second emptying valve between the filter assembly and the sewage pipe to empty the filter assembly, opening a third emptying valve between the feeding pump and the sewage pipe to empty the feeding pump, opening a fourth emptying valve between the discharge port of the membrane structure and the sewage pipe to empty the membrane structure, and opening a fifth emptying valve between the circulating pump and the sewage pipe to empty the circulating pump;
step two: introducing water into the raw material tank through a water inlet, introducing pickling liquid from a pickling batching tank and alkaline washing liquid from an alkaline washing batching tank into the raw material tank, opening the third valve of the filter assembly and the return valve at the discharge port of the heat exchanger, and turning on the feeding pump and the circulating pump for cleaning;
step three: stopping the circulating pump and the feeding pump in turn after the cleaning is completed; and
step four: turning on a hot air blower to evaporate moisture in the device and a pipeline.

14. A vegetable oil production method implemented by the vegetable oil production device according to claim 6, comprising:
a filtering process comprising following steps:
step one: pouring materials into the raw material tank, opening a second valve at the discharge port of the raw material tank, a third valve of the filter assembly, and a return valve at the discharge port of the heat exchanger;
step two: turning on a feeding pump, conveying the materials in the raw material tank to the membrane structure, filling the membrane structure and each pipeline with the materials, and exhausting air in the membrane structure and each pipeline;
step three: opening a first valve at the clear liquid outlet of the membrane structure, turning on a circulating pump to make the materials circulate in each of the plurality of membrane assemblies of the membrane structure;
step four: regulating a degree of opening of the first valve so as to keep a pressure gauge at the clear liquid outlet of the membrane structure within a range of a working pressure, and enabling clear liquid of the materials in the plurality of membrane assemblies to permeate a side wall of each membrane tube under an action of a transmembrane pressure difference between the circulating pump and the plurality of membrane assemblies; and
step five: collecting the clear liquid flowing out from the clear liquid outlet of the membrane structure, returning concentrated liquid remaining in the membrane structure after filtering to the raw material tank for second filtering after heat exchange by the heat exchanger, and stopping the circulating pump and the feeding pump in turn after the second filtering is completed;
a cleaning process comprising following steps:
step one: opening a first emptying valve at the discharge port of the raw material tank to empty the raw material tank, opening a second emptying valve between the filter assembly and the sewage pipe to empty the filter assembly, opening a third emptying valve between the feeding pump and the sewage pipe to empty the feeding pump, opening a fourth emptying valve between the discharge port of the membrane structure and the sewage pipe to empty the membrane structure, and opening a fifth emptying valve between the circulating pump and the sewage pipe to empty the circulating pump;
step two: introducing water into the raw material tank through the water inlet, introducing pickling liquid from the pickling batching tank and alkaline washing liquid from the alkaline washing batching tank into the raw material tank, opening the third valve of the filter assembly and the return valve at the discharge port of the heat exchanger, and turning on the feeding pump and the circulating pump for cleaning;
step three: stopping the circulating pump and the feeding pump in turn after the cleaning is completed; and
step four: turning on a hot air blower to evaporate moisture in the device and a pipeline.

15. A vegetable oil production method implemented by the vegetable oil production device according to claim 7, comprising:
a filtering process comprising following steps:
step one: pouring materials into the raw material tank, opening a second valve at the discharge port of the raw material tank, a third valve of the filter assembly, and a return valve at the discharge port of the heat exchanger;
step two: turning on a feeding pump, conveying the materials in the raw material tank to the membrane structure, filling the membrane structure and each pipeline with the materials, and exhausting air in the membrane structure and each pipeline;
step three: opening a first valve at the clear liquid outlet of the membrane structure, turning on a circulating pump to make the materials circulate in each of the plurality of membrane assemblies of the membrane structure;
step four: regulating a degree of opening of the first valve so as to keep a pressure gauge at the clear liquid outlet of the membrane structure within a range of a working pressure, and enabling clear liquid of the materials in the plurality of membrane assemblies to permeate a side wall of each membrane tube under an action of a transmembrane pressure difference between the circulating pump and the plurality of membrane assemblies; and
step five: collecting the clear liquid flowing out from the clear liquid outlet of the membrane structure, returning concentrated liquid remaining in the membrane structure after filtering to the raw material tank for second filtering after heat exchange by the heat exchanger, and stopping the circulating pump and the feeding pump in turn after the second filtering is completed;
a cleaning process comprising following steps:
step one: opening a first emptying valve at the discharge port of the raw material tank to empty the raw material tank, opening a second emptying valve between the filter assembly and the sewage pipe to empty the filter assembly, opening a third emptying valve between the feeding pump and the sewage pipe to empty the feeding pump, opening a fourth emptying valve between the discharge port of the membrane structure and the sewage pipe to empty the membrane structure, and opening a fifth emptying valve between the circulating pump and the sewage pipe to empty the circulating pump;
step two: introducing water into the raw material tank through the water inlet, introducing pickling liquid from the pickling batching tank and alkaline washing liquid from the alkaline washing batching tank into the raw material tank, opening the third valve of the filter assembly and the return valve at the discharge port of the heat exchanger, and turning on the feeding pump and the circulating pump for cleaning;
step three: stopping the circulating pump and the feeding pump in turn after the cleaning is completed; and
step four: turning on a hot air blower to evaporate moisture in the device and a pipeline.

16. A vegetable oil production method implemented by the vegetable oil production device according to claim 8, comprising:
a filtering process comprising following steps:
step one: pouring materials into the raw material tank, opening a second valve at the discharge port of the raw material tank, a third valve of the filter assembly, and a return valve at the discharge port of the heat exchanger;
step two: turning on a feeding pump, conveying the materials in the raw material tank to the membrane structure, filling the membrane structure and each pipeline with the materials, and exhausting air in the membrane structure and each pipeline;
step three: opening a first valve at the clear liquid outlet of the membrane structure, turning on a circulating pump to make the materials circulate in each of the plurality of membrane assemblies of the membrane structure;
step four: regulating a degree of opening of the first valve so as to keep a pressure gauge at the clear liquid outlet of the membrane structure within a range of a working pressure, and enabling clear liquid of the materials in the plurality of membrane assemblies to permeate a side wall of each membrane tube under an action of a transmembrane pressure difference between the circulating pump and the plurality of membrane assemblies; and
step five: collecting the clear liquid flowing out from the clear liquid outlet of the membrane structure, returning concentrated liquid remaining in the membrane structure after filtering to the raw material tank for second filtering after heat exchange by the heat exchanger, and stopping the circulating pump and the feeding pump in turn after the second filtering is completed;
a cleaning process comprising following steps:
step one: opening a first emptying valve at the discharge port of the raw material tank to empty the raw material tank, opening a second emptying valve between the filter assembly and the sewage pipe to empty the filter assembly, opening a third emptying valve between the feeding pump and the sewage pipe to empty the feeding pump, opening a fourth emptying valve between the discharge port of the membrane structure and the sewage pipe to empty the membrane structure, and opening a fifth emptying valve between the circulating pump and the sewage pipe to empty the circulating pump;
step two: introducing water into the raw material tank through a water inlet, introducing pickling liquid from a pickling batching tank and alkaline washing liquid from an alkaline washing batching tank into the raw material tank, opening the third valve of the filter assembly and the return valve at the discharge port of the heat exchanger, and turning on the feeding pump and the circulating pump for cleaning;
step three: stopping the circulating pump and the feeding pump in turn after the cleaning is completed; and
step four: turning on the hot air blower to evaporate moisture in the device and a pipeline.
